(19) United States
(12) Patent Application Publication
(10) Pub. No.: US 2025/0212861 A1
(43) Pub. Date: Jul. 3, 2025

(54) Buoyant Fishing Case Device

(71) Applicant: Roger Lockhart, Skiatook, OK (US)

(72) Inventor: Roger Lockhart, Skiatook, OK (US)

(21) Appl. No.: 18/917,216

(22) Filed: Oct. 16, 2024

Related U.S. Application Data
(60) Provisional application No. 63/616,046, filed on Dec. 29, 2023.

(51) Int. Cl. A01K 97/08; B65D 25/20; B65D 25/28; B65D 25/34; B65D 43/16; B65D 43/22; B65D 51/28; B65D 53/02

(52) U.S. Cl. CPC A01K 97/08; B65D 25/20; B65D 25/2808; B65D 25/34; B65D 43/163; B65D 43/22; B65D 51/28; B65D 53/02; B65D 2203/00; B65D 2543/00194; B65D 2543/00972

(57) ABSTRACT

A buoyant fishing case device is provided. The device is comprised of a buoyant device with an interior space that can store fishing poles and a plurality of fishing-related supplies. The exterior surface of the device may be reflective, phosphorescent, or fluorescent to allow the device to be easily seen if it falls into a body of water.

### CROSS-REFERENCE TO RELATED APPLICATION

The present application claims priority to, and the benefit of, U.S. Provisional Application No. 63/616,046, which was filed on Dec. 29, 2023, and is incorporated herein by reference in its entirety.

### FIELD OF THE INVENTION

The present invention relates generally to the field of fishing accessories. More specifically, the present invention relates to a buoyant fishing case device that provides a buoyant case that can store fishing poles and other fishing supplies, wherein the device is also highly visible when in a body of water to allow the device to be easily located and retrieved. Accordingly, the present disclosure makes specific reference thereto. Nonetheless, it is to be appreciated that aspects of the present invention are also equally applicable to other like applications, devices, and methods of manufacture.

### BACKGROUND

Individuals who fish often have a collection of several fishing poles, each potentially serving a specific purpose or suited for different fishing environments. The act of carrying multiple fishing poles by hand is a task that requires careful handling. It is not simply about the physical effort but also about ensuring that the poles do not suffer any damage. This challenge is heightened by the delicate nature of fishing equipment, where even minor impacts can lead to significant damage.

The risk of dropping or damaging the poles is just one aspect of the larger issue. Another common problem faced during the transportation of multiple fishing poles is the tangling of lines. Lines can easily become entwined around the rods or other objects, leading to a time-consuming and often frustrating process of untangling. Moreover, tangled lines can weaken or break, necessitating their replacement.

In addition to the risk of tangling, the rods themselves are prone to breaking. A broken rod not only disrupts a fishing trip but also incurs additional costs. Given the often high cost of quality fishing equipment, replacing a broken rod can be a significant financial setback.

The financial aspect is further compounded by the risk of accidentally dropping fishing poles into the water. Such incidents can occur, especially in scenarios where the individual is navigating uneven terrain, boarding a boat, or fishing in areas with slippery or unstable surfaces. Once a pole falls into the water, especially in deep or fast-moving bodies of water, the chances of retrieving it diminish greatly. The loss of a pole in such a manner is not just a loss of a tool but can also have sentimental implications, particularly if the pole has been a part of many successful fishing expeditions or has sentimental value.

Therefore, there exists a long-felt need in the art for a device for carrying fishing poles and other fishing-related supplies. There also exists a long-felt need in the art for a buoyant fishing case device. More specifically, there exists a long-felt need in the art for a buoyant fishing case device that can house a plurality of fishing poles in a protected manner. Further, there exists a long-felt need in the art for a buoyant fishing case device that can house a plurality of fishing poles in a protected manner wherein the device is buoyant. In addition, there exists a long-felt need in the art for a buoyant fishing case device that can house a plurality of fishing poles in a protected manner wherein the device is buoyant and can be easily seen.

The subject matter disclosed and claimed herein, in one embodiment thereof, comprises a buoyant fishing case device. The device is comprised of a buoyant device with an interior space that can store fishing poles and a plurality of fishing-related supplies. The exterior surface of the device may be reflective, phosphorescent, or fluorescent to allow the device to be easily seen if it falls into a body of water.

In this manner, the buoyant fishing case device of the present invention accomplishes all the foregoing objectives and provides a device for carrying fishing poles and other fishing-related supplies. More specifically, the device can house a plurality of fishing poles in a protected manner. Further, the device is buoyant and can be easily seen such that it can be easily retrieved if it falls into a body of water.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a buoyant fishing case device. The device is comprised of a buoyant body with an interior space that can be used to house fishing supplies. The body may be made of any buoyant material. The body (and/or lid) may be comprised of at least one element positioned on the exterior surface of the body. The element (and/or the entire exterior surface of the body and/or lid) may be made from a reflective, phosphorescent, and/or fluorescent material of any color such that the device can be easily seen while floating in a body of water in the event that the device falls overboard from a vessel while fishing during day or night. The device is also comprised of at least one lid that preferably attaches to the body via at least one hinge. The lid can be secured to the body via at least one locking mechanism.

The body and/or lid are comprised of at least one interior space that can be used to store various fishing-related items. More specifically, in one embodiment the interior space is comprised of at least one receiving area for fishing poles. A fishing pole may be further secured into the area via at least one fastener such as, but not limited to, a strap, a clip, a clamp, a magnet, etc. The interior space may also be comprised of at least one storage compartment that can be used to store various fishing-related items such as, but not limited to, bait, lures, fishing lines, etc.

In one embodiment, the interior space is comprised of at least one light to aid in viewing supplies within the body in low-light environments. The light may be any light type of any color. The light may be a plurality of brightness levels, illumination modes, etc. In one embodiment, the light can be controlled and configured via at least one button. In another embodiment, the light is motion-activated such that the light automatically illuminates for a period of time when motion of the lid (and/or an area within the interior space) is detected.

The present invention is also comprised of a method of using the device. First, a device is provided comprised of a body comprised of an interior space and at least one lid (wherein the body is buoyant), wherein an exterior surface of the body is comprised of at least one element. Then, a user can place at least one fishing pole into a receiving area of the interior space and/or place fishing supplies into at least one compartment of the interior space. Optionally, a user can further secure the pole into the receiving area via at least one fastener. Then, the lid can be closed and secured to the body via at least one locking mechanism. Finally, a user can locate the device via the visibility of the element in the event the device falls aboard into a body of water, wherein the device can then be retrieved from said body of water.

Accordingly, the buoyant fishing case device of the present invention is particularly advantageous as it provides a device for carrying fishing poles and other fishing-related supplies. More specifically, the device can house a plurality of fishing poles in a protected manner. Further, the device is buoyant and can be easily seen such that it can be easily retrieved if it falls into a body of water. In this manner, the buoyant fishing case device provides a solution to protecting fishing poles and fishing-related supplies, and allowing said supplies to be easily retrieved if the device falls overboard.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a buoyant fishing case device of the present invention while closed in accordance with the disclosed architecture;

FIG. 2 illustrates a top view of one potential embodiment of a buoyant fishing case device of the present invention while open in accordance with the disclosed architecture; and

FIG. 3 illustrates a flowchart of a method of using one potential embodiment of a buoyant fishing case device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for carrying fishing poles and other fishing-related supplies. There also exists a long-felt need in the art for a buoyant fishing case device. More specifically, there exists a long-felt need in the art for a buoyant fishing case device that can house a plurality of fishing poles in a protected manner. Further, there exists a long-felt need in the art for a buoyant fishing case device that can house a plurality of fishing poles in a protected manner wherein the device is buoyant. In addition, there exists a long-felt need in the art for a buoyant fishing case device that can house a plurality of fishing poles in a protected manner wherein the device is buoyant and can be easily seen.

The present invention, in one exemplary embodiment, is comprised of a buoyant fishing case device comprised of a buoyant body with an interior space that can be used to house fishing supplies. The body may be made of any buoyant material. Further, the body (and/or lid) may be comprised of at least one element positioned on the exterior surface of the body that may be made from a reflective, phosphorescent, and/or fluorescent material of any color such that the device can be easily seen while floating in a body of water in the event that the device falls overboard from a vessel while fishing during day or night. The device is also comprised of at least one lid that preferably attaches to the body via at least one hinge. The lid can be secured to the body via at least one locking mechanism.

The body and/or lid are comprised of at least one interior space that can be used to store various fishing-related items. More specifically, in one embodiment the interior space is comprised of at least one receiving area for fishing poles, wherein a fishing pole may be further secured into the area via at least one fastener such as, but not limited to, a strap, a clip, a clamp, a magnet, etc. The interior space may also be comprised of at least one storage compartment that can be used to store various fishing-related items such as, but not limited to, bait, lures, fishing lines, etc.

In one embodiment, the interior space is comprised of at least one light to aid in viewing supplies within the body in low-light environments. The light may be any light type of any color. The light may be a plurality of brightness levels, illumination modes, etc. In one embodiment, the light can be controlled and configured via at least one button. In another embodiment, the light is motion-activated such that the light automatically illuminates for a period of time when motion of the lid (and/or an area within the interior space) is detected.

The present invention is also comprised of a method of using the device. First, a device is provided comprised of a body comprised of an interior space and at least one lid (wherein the body is buoyant), wherein an exterior surface of the body is comprised of at least one element. Then, a user can place at least one fishing pole into a receiving area of the interior space and/or place fishing supplies into at least one compartment of the interior space. Optionally, a user can further secure the pole into the receiving area via at least one fastener. Then, the lid can be closed and secured to the body via at least one locking mechanism. Finally, a user can locate the device via the visibility of the element in the event the device falls aboard into a body of water, wherein the device can then be retrieved from said body of water.

Accordingly, the buoyant fishing case device of the present invention is particularly advantageous as it provides a device for carrying fishing poles and other fishing-related supplies. More specifically, the device can house a plurality of fishing poles in a protected manner. Further, the device is buoyant and can be easily seen such that it can be easily retrieved if it falls into a body of water. In this manner, the buoyant fishing case device provides a solution to protecting fishing poles and fishing-related supplies, and allowing said supplies to be easily retrieved if the device falls overboard.

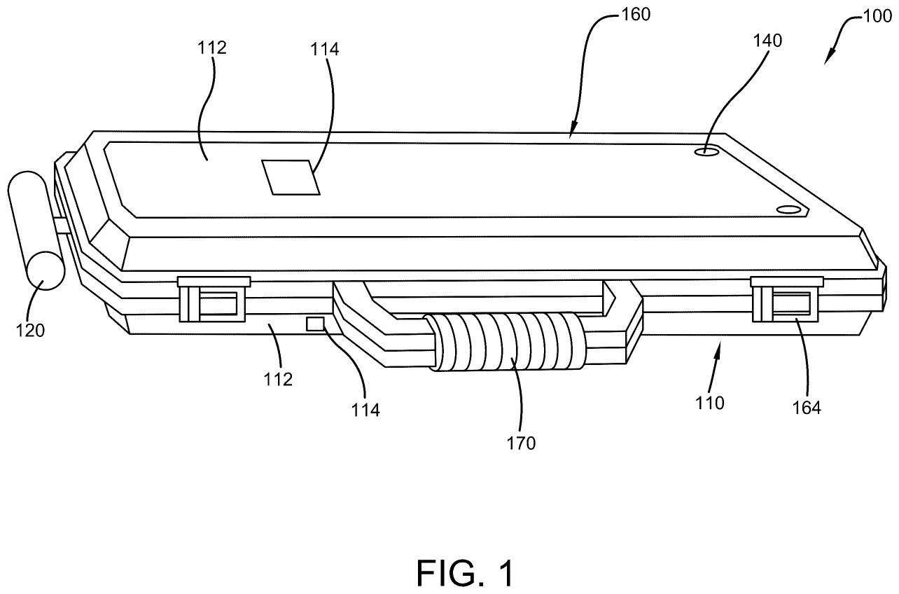

Referring initially to the drawings, FIG. 1 illustrates a front perspective view of one potential embodiment of a buoyant fishing case device 100 of the present invention while closed in accordance with the disclosed architecture. The device 100 is comprised of a buoyant body 110 with an interior space 130 that can be used to house fishing supplies. The body 110 may be made of any buoyant material (of any buoyant design/configuration) in different embodiments. The body 110 is preferably made from a buoyant, waterproof plastic. In one embodiment, the body 110 may have at least one floatation attachment 120 that removably attaches (externally) to the body 110 to ensure the body 110 is buoyant. The attachment 120 may be any attachment type/steal that is buoyant.

The body 110 (and/or lid 160) may be comprised of at least one element 114 positioned on the exterior surface 112 of the body 110. The element 114 (and/or the entire exterior surface 112 of the body 110 and/or lid 160) may be made from a reflective, phosphorescent, and/or fluorescent material of any color. In this manner, the device 100 can be easily seen while floating in a body of water in the event that the device 100 falls overboard from a vessel while fishing during the day or night. The element 114 of the body 110 and/or lid 160 may also be any color/pattern such as, but not limited to, camouflage.

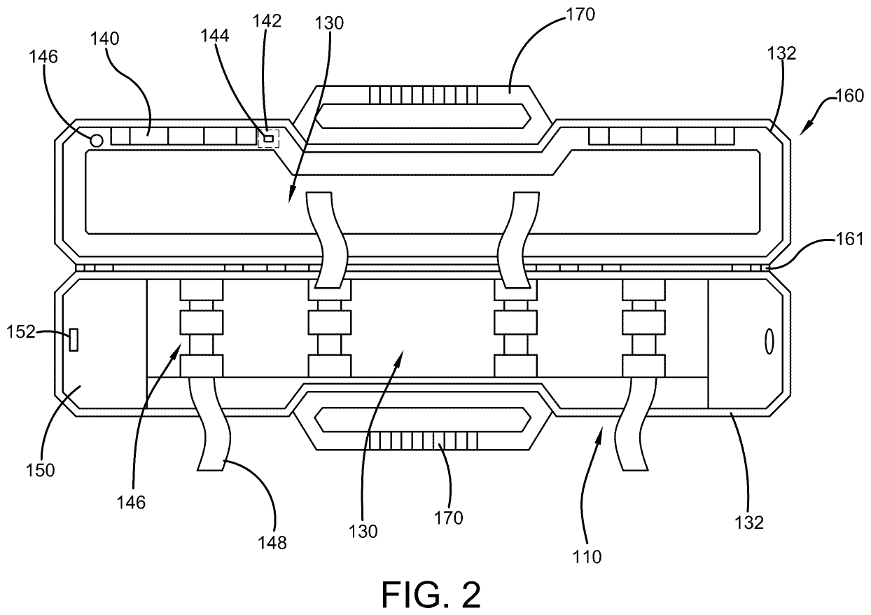

The device 100 is also comprised of at least one lid 160. The lid 160 preferably attaches to the body 110 via at least one hinge 162 (of any hinge type). The lid 160 can be secured to the body 110 via at least one locking mechanism 164, as seen in FIG. 2. In this manner, the body 110 cannot be inadvertently opened. The locking mechanism 164 may include, but is not limited to, a clasp, a latch, a key lock, a dial lock, a snap lock, etc. The lid 160 and/or body 110 may be comprised of at least one handle 170 (of any type) that allows the device 100 to be carried.

The body 110 and/or lid 160 is comprised of at least one interior space 130. The interior space 130 can be used to store various fishing-related items. More specifically, in one embodiment the interior space 130 is comprised of at least one receiving area 146 for fishing poles. The area 146 may be any style of fishing pole receiving area such as, but not limited to, a recessed area, a clip, etc. A fishing pole may be further secured into the area 146 via at least one fastener 148 such as, but not limited to, a strap, a clip, a clamp, a magnet, etc.

The interior space 130 may also be comprised of at least one storage compartment 150. The compartment 150 may be an open compartment or a compartment having a lid. The compartment 150 can be used to store various fishing-related items such as, but not limited to, bait, lures, fishing lines, etc. In a lid-compartment embodiment, the compartment 150 may be comprised of at least one locking mechanism 152 that secures compartment 150 in a closed position. The mechanism 152 may include, but is not limited to, a clasp, a latch, a key lock, a dial lock, a snap lock, etc.

In one embodiment, the interior space 130 is comprised of at least one light 140 to aid in viewing supplies within the body 110 in low-light environments. The light 140 may be any light type of any color. The light 140 may be a plurality of brightness levels, illumination modes, etc. In one embodiment, the light 140 can be controlled and configured via at least one button 146. In another embodiment, the light 140 is motion-activated such that the light 140 automatically illuminates for a period of time when motion of the lid 160 (and/or an area within the interior space 130) is detected. The light 140 is powered by at least one battery 142 that may be removable or non-removable. The light 142 may also be rechargeable or disposable. In a rechargeable embodiment, the battery 142 can be recharged via at least one charging port 144 such as, but not limited to, a USB port.

In another embodiment, the lights 140 are positioned on the exterior surface 112. In this embodiment, the lights 140 are water-activated such that they light 140 illuminates when it contacts water. As a result, the light 140 automatically illuminates when the device 100 is dropped in a body of water to aid a user in further locating the device 100.

In one embodiment, the body 110 is waterproofed via at least one waterproof gasket/seal found on the lid 160 and/or body 110. The gasket 132 may be any waterproof gasket type known in the art.

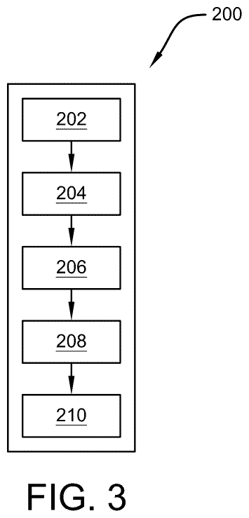

The present invention is also comprised of a method of using 200 the device 100, as seen in FIG. 3. First, a device 100 is provided comprised of a body 110 comprised of an interior space 130 and at least one lid 160 (wherein the body 110 is buoyant), wherein an exterior surface 112 of the body 110 is comprised of at least one element 114 [Step 202]. Then, a user can place at least one fishing pole into a receiving area 146 of the interior space 130 and/or place fishing supplies into at least one compartment 150 of the interior space 130 [Step 204]. Optionally, a user can further secure the pole into the receiving area 146 via at least one fastener 148 [Step 206]. Then, the lid 160 can be closed and secured to the body 110 via at least one locking mechanism 164 [Step 208]. Finally, a user can locate the device 100 via the visibility of the element 114 in the event the device 100 falls aboard into a body of water, wherein the device 100 can then be retrieved from said body of water [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “buoyant fishing case device” and “device” are interchangeable and refer to the buoyant fishing case device 100 of the present invention.

Notwithstanding the foregoing, the buoyant fishing case device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the buoyant fishing case device 100 as shown in the FIGS. are for illustrative purposes only, and that many other sizes and shapes of the buoyant fishing case device 100 are well within the scope of the present disclosure. Although the dimensions of the buoyant fishing case device 100 are important design parameters for user convenience, the buoyant fishing case device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A buoyant fishing case device comprising:
a buoyant body comprised of an interior space and a lid;
an element positioned on an exterior surface of the body;
a receiving area positioned within the interior space;
a light positioned within the interior space; and
a waterproof gasket.

2. The buoyant fishing case device of claim 1, wherein the buoyant body is comprised of a handle.

3. The buoyant fishing case device of claim 1, wherein the element is comprised of a reflective, a phosphorescent, or a fluorescent element.

4. The buoyant fishing case device of claim 3, wherein the element is comprised of a color.

5. The buoyant fishing case device of claim 1, wherein the lid is comprised of a first locking mechanism that secures the lid to the body.

6. The buoyant fishing case device of claim 1, wherein the interior space is comprised of a storage compartment.

7. The buoyant fishing case device of claim 6, wherein the storage compartment is comprised of a lid-compartment.

8. The buoyant fishing case device of claim 7, wherein the storage compartment is comprised of a second locking mechanism.

9. The buoyant fishing case device of claim 1, wherein the receiving area is comprised of a fishing pole receiving area.

10. A buoyant fishing case device comprising:
a buoyant body comprised of an interior space and a lid;
an element positioned on an exterior surface of the body;
a receiving area positioned within the interior space;
a light positioned within the interior space;
a waterproof gasket; and
a floatation attachment that removably attaches to the buoyant body.

11. The buoyant fishing case device of claim 10, wherein the buoyant body is comprised of a handle.

12. The buoyant fishing case device of claim 10, wherein the element is comprised of a reflective, a phosphorescent, or a fluorescent element.

13. The buoyant fishing case device of claim 12, wherein the element is comprised of a color.

14. The buoyant fishing case device of claim 10, wherein the lid is comprised of a first locking mechanism that secures the lid to the body.

15. The buoyant fishing case device of claim 10, wherein the interior space is comprised of a storage compartment.

16. The buoyant fishing case device of claim 15, wherein the storage compartment is comprised of a lid-compartment.

17. The buoyant fishing case device of claim 16, wherein the storage compartment is comprised of a second locking mechanism.

18. The buoyant fishing case device of claim 10, wherein the receiving area is comprised of a fishing pole receiving area.

19. The buoyant fishing case device of claim 10, wherein the light is comprised of a motion-activated light.

20. A method of using a buoyant fishing case device, the method comprising the following steps:
providing a buoyant fishing case device comprised of a body comprised of an interior space and a lid, wherein an exterior surface of the body is comprised of an element;
placing a fishing pole into a receiving area of the interior space;
closing the lid and securing the lid to the body via a locking mechanism;
locating the buoyant fishing case device in a body of water via the element; and
retrieving the buoyant fishing case device from the body of water.
